(19) United States
(12) Patent Application Publication
(10) Pub. No.: US 2004/0203450 A1
(43) Pub. Date: Oct. 14, 2004

(54) Call admission apparatus and method for guaranteeing quality of service in a mobile communication system

(76) Inventor: Ki-Ho Cho, Songnam-shi (KR)

Correspondence Address: Roylance, Abrams, Berdo & Goodman, L.L.P., 1300 19th Street, N.W. , Suite 600, Washington, DC, 20036, US

(21) Appl. No.: 10/406,270

(22) Filed: Apr. 4, 2003

(30) Foreign Application Priority Data
May 27, 2002 (KR) 2002-29209

(51) Int. Cl. H04B 17/00; H04B 7/00

(52) U.S. Cl. 455/67.11; 455/522

(57) ABSTRACT

A call admission apparatus and method for guaranteeing a Quality of Service (QoS) in a mobile communication system are disclosed. Upon sensing a call admission request for a new call, a minimum transmit power required to maintain the QoS of each call in service is detected. Only if the sum of the minimum transmit powers of calls in service is less than an optimum transmit power is the call admitted. Therefore, efficient use of transmit power resources is increased.

### PRIORITY

This application claims priority under 35 U.S.C. § 119 to an application entitled “Call Admission Apparatus and Method for Guaranteeing Quality of Service in a Mobile Communication System and a Method Thereof” filed in the Korean Industrial Property Office on May 27, 2002 and assigned Serial No. 2002-29209, the contents of which are incorporated herein by reference.

### BACKGROUND OF THE INVENTION

1. Field of the Invention

The present invention relates generally to a mobile communication system, and in particular, to a call admission apparatus and method for guaranteeing Quality of Service (QoS).

2. Description of the Related Art

Mobile communication technology has been developed to provide a variety of services including packet data service as well as voice service. FIG. 1 is a block diagram illustrating a conventional mobile communication system.

Referring to FIG. 1, the mobile communication system comprises a mobile switching center (MSC) 130, a home location register (HLR) 140, plurality of base station controllers (BSCs), and plurality of base transceiver subsystems (BTSs), and plurality Mobile stations (MSs). Here, there are the plurality of BSCs and the plurality of BTSs, but as a matter of convenience for description, for example, a BTS 110, and a BSC 120, and a MS 100 is described in FIG.1. The MS 100 can be connected to the public switched telecommunication network (PSTN) 160 and a public land mobile network (PLMN) 150 through wireless connection to the BTS 110. The BSC 120 controls wired and wireless links and handover. The BTS 110 establishes radio communication paths with the MS 100 and manages radio resources. The HLR 140 registers subscriber locations. A visitor location register (VLR not shown) also registers the locations of mobile subscribers.

The mobile communication system, particularly a next generation mobile communication system such as International Mobile Telecommunication 2000 (IMT-2000) provides various services including voice service. The various services require different QoS levels and have priority levels according to the QoS levels.

Efficient management of radio resources directly influences the overall service quality of the mobile communication system. Therefore, each service has a corresponding QoS and is given a priority level according to the corresponding QoS.

Four QoS classes are defined in the IMT-2000 communication system: conversational class, streaming class, interactive class, and background class. The conversational class is granted to real time traffic services which are provided at low data rate, are error-tolerant, and delay-sensitive. Video telephony is an example of a service that falls within the conversational class. The streaming class carries one-directional broadcast traffic flows such as TV broadcasting. It is given to real time services which are sensitive to errors and require a high data rate e.g., <128 Kbps. The interactive class is mainly meant to be used for traditional Internet applications like the World Wide Web (WWW). Interactive traffic is characterized by very high data rate e.g., <2 Mbps, better error rate, and short Round Trip Time (RTT). Finally, the background class applies to traffic delivered in large amounts and is sensitive to errors, such as File Transfer Protocol(FTP). In this mobile communication system, a resources allocation and traffic control algorithm must be configured such that resources are assigned to each call according to its QoS class and the QoS is guaranteed by control of the traffic. Efficient assignment of radio resources maximizes the overall throughput of the mobile communication system.

Accordingly, a new call or handover call is admitted according to the amount of the total radio resources in use in order to prevent an overload on the whole system.

FIG. 2 is a flowchart illustrating an example of operations for performing call admission in a conventional mobile communication system. Upon generation of a new call or handover call, a BTS admits the call as long as the QoS of calls currently being serviced can be guaranteed. The dominant factor that determines the service capacity on the forward link is a transmit power. The BTS, therefore, first determines whether the transmit power is available to the call. If the transmit power is available, the BTS then determines whether other resources are available to the call. Co-channel interference on the forward link influences the transmit power, but it is negligibly small in the IMT-2000 system because of the use of Orthogonal Variable Spreading Factor (OVSF) codes as channelization codes to maintain orthogonality between channels.

Referring to FIG. 2, upon receipt of a call request in step 211, the BTS proceeds to step 213. The call request is issued when a new call, a handover call, or a call for data rate adjustment is generated. The call request takes the form of an Radio Access Bearer (RAB) Assignment Request message, which is transmitted from a BSC to the BTS in order to set an RAB. The BTS detects traffic parameters in the RAB Assignment Request message in step 213. The traffic parameters include the service class i.e., QoS class, minimum rate, guaranteed rate, Bit Error Rate (BER), and initial transmit power.

In step 215, the BTS compares the sum of the transmit power P_{used} in current use and the transmit power Pᵢ required for the call i with a maximum transmit power available to the BTS, that is, the optimum transmit power Pₒₚₜ (P_{used}+Pᵢ<Pₒₚₜ). The optimum transmit power Pₒₚₜ is the maximum transmit power that the BTS can assign to provide service reliably. Hence, if more than the optimum transmit power Pₒₚₜ is assigned, the QoS may be degraded. If P_{used}+PᵢPₒₚₜ, the BTS notifies the BSC that the call cannot be admitted in step 217.

On the contrary, if P_{used}+Pᵢ<Pₒₚₜ, the BTS determines that the call can be admitted and assigns the transmit power to the call in step 219. The BTS then processes the call in step 221 and terminates the procedure.

As described above, the BTS admits a call only when the sum of the total transmit power in current use and the transmit power required for the call is less than the optimum transmit power. However, this call admission algorithm is feasible for traditional mobile communication systems that mainly provide voice service, but has limitations in a mobile communication system providing various services such as the IMT-2000 system. For example, since the IMT-2000 communication system provides a data service at a best-effort basis. That is, the IMT-2000 transmits data at a maximum available data rate, it assigns a current maximum available data rate to the data service at call admission, thereby improving system service quality. If all the available transmit power at the moment of call admission is assigned to the data service, later calls cannot be admitted or are assigned to relatively less transmit power. The unfair power assignment leads to a high call blocking rate. As compared to the above call admission algorithm, a call admission algorithm has been proposed in which a predetermined amount of transmit power is spared for later calls. This call admission algorithm decreases resource use efficiency as much as the spared transmit power, and causes the same problem as the call admission algorithm of FIG. 2 when many call requests are generated concurrently.

### SUMMARY OF THE INVENTION

It is, therefore, an object of the present invention to provide an apparatus and method for admitting a call according to the QoS class of the call in a mobile communication system.

It is another object of the present invention to provide a call admission apparatus and method for maximizing the use efficiency of transmit power resources in a mobile communication system.

It is a further object of the present invention to provide an apparatus and method for admitting a call in consideration of the minimum rates of calls in current service in a mobile communication system.

To achieve the above and other objects, according to one aspect of the present invention, in a call admission apparatus for guaranteeing a QoS in a mobile communication system, a call state information collector adapted to collect call state information about calls in service. A call admission controller, adapted to detect from the call state information a minimum transmit power required to maintain the QoS for each of the calls in service upon sensing a call admission request for a new call, and admit the new call only if the sum of the total minimum transmit power of the calls in service and the minimum transmit power required to maintain the QoS of the new call is less than a predetermined optimum transmit power.

According to another aspect of the present invention, in a call admission method for guaranteeing a QoS in a mobile communication system, detecting a minimum transmit power required to maintain QoS for each of the calls in service upon sensing a call admission request for a new call. The method further comprises admitting the new call only if the sum of the total minimum transmit power of the calls in service and the minimum transmit power required to maintain the QoS of the new call is less than a predetermined optimum transmit power, the new call is admitted.

According to a further aspect of the present invention, in a call admission method for guaranteeing a QoS in a mobile communication system, first transmit power assigned to calls in service is detected, upon sensing a call admission request for a new call. A third value is calculated by subtracting a second value being the sum of minimum rates required to maintain the QoS of the calls in service from a first value being the sum of the current rates of the calls in service. A fifth value is calculated by multiplying the third value by a fourth value being the bandwidth of the mobile communication system. A sixth value is calculated by subtracting the fifth value from the first transmit power. Only if a seventh value being the sum of the sixth value and minimum transmit power required to maintain the QoS of the new call is less than a predetermined optimum transmit power, the new call is admitted.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a conventional mobile communication system;

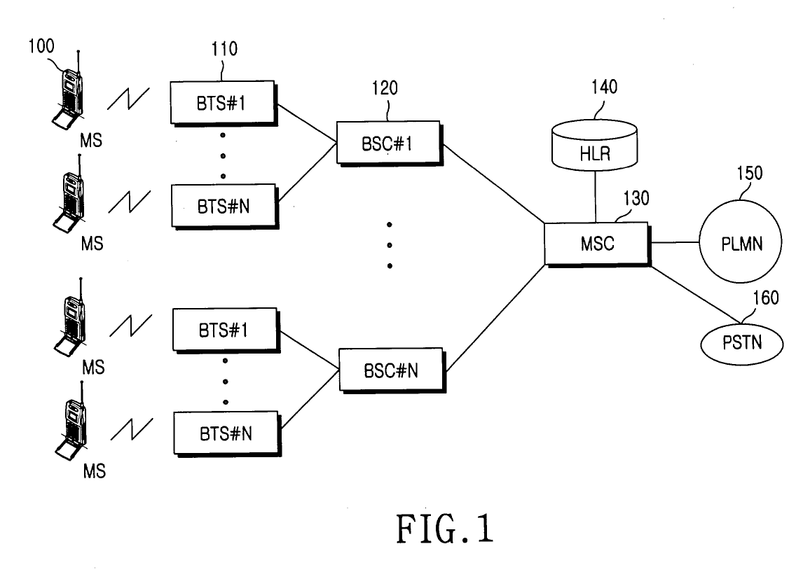

FIG. 2 is a flowchart illustrating an operations for performing call admission in a conventional mobile communication system;

FIG. 3 is a block diagram of a call admission apparatus according to an embodiment of the present invention;

FIG. 4 is a flowchart illustrating an operations for performing call admission according an embodiment of to the present invention;

FIG. 5 is a flowchart illustrating another operations for performing call admission according to an embodiment of the present invention;

FIG. 6 is a graph illustrating a comparison of call success rates in a conventional call admission method and call success rates for call admission according to an embodiment of the present invention; and

FIG. 7 is a graph illustrating a comparison of a maximum acceptable path loss versus the ratio of minimum transmit power Pₘᵢₙ to optimum transmit power Pₒₚₜ using a conventional call admission method and a call admission method according to an embodiment of the present invention.

### DETAILED DESCRIPTION OF THE PREFERRED EMBODIMENTS

Several embodiments of the present invention will now be described herein with reference to the accompanying drawings. In the following description, well-known functions or constructions have been omitted for conciseness.

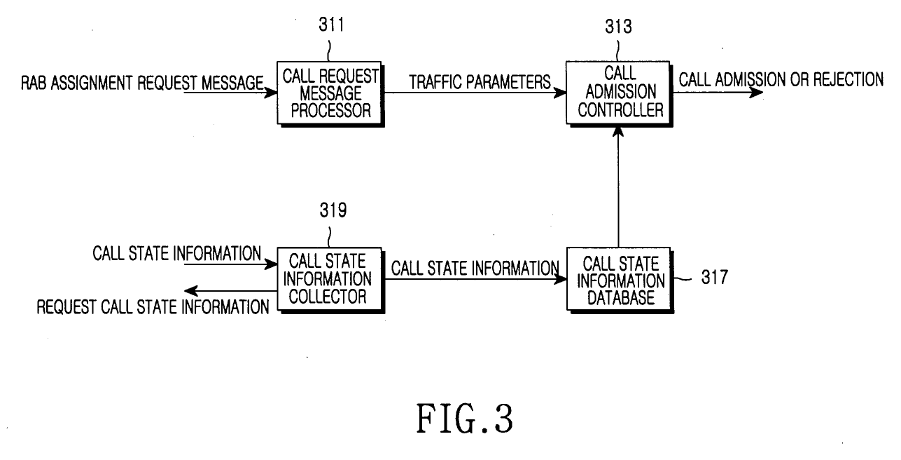

FIG. 3 is a block diagram of a call admission apparatus according to an embodiment of the present invention. Referring to FIG. 3, a BSC requests admission of a call to a BTS using an RAB Assignment Request message for setting an RAB. A call request processor 311 extracts information about call characteristics from the RAB Assignment Request message. The call characteristics information can be traffic parameters including service class i.e., QoS class, minimum rate, guaranteed rate, BER, and initial transmit power.

A call admission controller 313 determines whether to admit the call according to the call characteristic information. The state of a corresponding cell is considered in the determination, which will be described below. The BTS can have one or more cells.

A call state information collector 319 transmits a call state information request to each cell according to a command from a higher layer in every predetermined period or upon generation of a particular event. The call state information will be described later. The call state information collector 319, if it receives call state information from the cells, provides the call state information to a call state information database 317. The call state information database 317 builds a database using the call state information for each cell. Needless to say, if the BTS has one cell, a single database is built. To decide whether to admit the call, the call admission controller 313 searches the call state information database 317 for the database corresponding to a cell which will be connected to the call. The call admission controller 317 determines whether to admit the call according to the call state information of the cell.

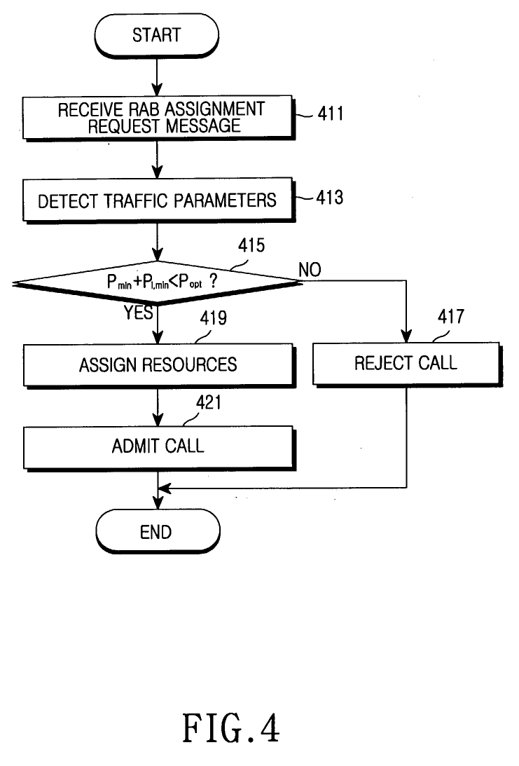

FIG. 4 is a flowchart illustrating an operations for performing a call admission according to an embodiment of the present invention. Referring to FIG. 4, upon receipt of a call request in step 411, the BTS proceeds to step 413. The call request is issued when a new call, a handover call, or a call for data rate adjustment is generated. The call request takes the form of an RAB Assignment Request message, which is transmitted from the BSC to the BTS in order to set an RAB. The BTS detects traffic parameters in the RAB Assignment Request message in step 413. The traffic parameters include a service class i.e., QoS class, minimum rate, guaranteed rate, BER, and initial transmit power. In accordance with an embodiment of the present invention, the minimum transmit power is computed using the minimum rate to determine whether to admit a call. The minimum transmit power varies depending on the path loss, required Eb/No, and BER. While the minimum transmit power is computed in many ways, it is preferably determined using the minimum rate and the BER in an embodiment of the present invention.

Many call state information parameters are used for the BTS in order to control the transmit power of calls in service. They are listed in Table 1 below.

TABLE 1

| Parameter | Meaning |
|---|---|
| P_{used} | Transmit power in current use, |
| | Transmitted carrier power |
| Pₒₚₜ | Optimum transmit power |
| R | The sum of the rates of calls in current |
| | service |
| Rₘᵢₙ | The sum of the minimum rates of calls |
| | in current service |
| P_{min,i} | Transmit power required for new call i |
| | at minimum rate |
| P_{overhead} | Power assigned to overhead channel |
| ρᵢ | Required Eb/No for channel i |
| rᵢ | Data rate of channel i (r_{min,i} is the |
| | minimum rate of channel i) |
| Nₜ | Thermal noise |
| Lᵢ | Path loss of channel i |
| W | Bandwidth, 3.84 MHz |
| vᵢ | Activity of call i |

Referring to Table 1, P_{used} is the total transmit power in use for the BTS, eventually transmitted carrier power. Pₒₚₜ is the maximum available transmit power without influencing the QoS, that is, optimum transmit power. R is the sum of the rates of calls currently in service, and Rₘᵢₙ is the sum of the minimum rates of the calls. P_{min,i} is the transmit power assigned to a call i at its minimum rate. P_{overhead} is the transmit power assigned to an overhead channel. ρᵢ is a required Eb/No for a channel i. rᵢ is the rate of the channel i and r_{min,i} is the minimum rate of the channel i. Nₜ is the thermal noise, Lᵢ is the path loss of the channel i, and W is a bandwidth, for example, 3.84 MHz. vᵢ is the activity of the call i.

When determining whether to admit a new call, the BTS considers the above call state information parameters in order to prevent degradation of the QoS of other calls in service. Otherwise, an overhead is imposed on the BTS and the resulting power shortage adversely influences the other calls in service, degrading their QoS.

In step 415, the BTS compares the sum of the minimum transmit power Pₘᵢₙ and the transmit power required to service the call i at its minimum rate with the optimum transmit power Pₒₚₜ. That is,

Pₘᵢₙ+P_{min,i}<Pₒₚₜ (1)

where Pₘᵢₙ is the total transmit power required to service all ongoing calls at their minimum rates with their QoS maintained.

If Pₘᵢₙ+P_{min,i} Pₒₚₜ, the BTS notifies the BSC that the call cannot be admitted in step 417 and terminates the call admission procedure.

On the contrary, if Pₘᵢₙ+P_{min,i}<Pₒₚₜ, the BTS determines that the call can be admitted and assigns the transmit power to the call in step 419. The BTS then processes the call in step 421 and terminates the call admission procedure.

However, it is very difficult to detect the minimum transmit power Pₘᵢₙ in a real radio channel environment because although an accurate minimum transmit power Pₘᵢₙ can be detected by the initial power control such as an open loop power control upon generation of an initial call request, the minimum transmit power Pₘᵢₙ of later calls varies according to the radio channel environment involving propagation loss, interference, and the movement of an MS. In accordance with the present invention, the minimum transmit power Pₘᵢₙ is computed as follows.

First, the required Eb/No ρᵢ for the call i is calculated by

$${ρ}_{i} = \frac{W}{{v}_{i} {L}_{i} {r}_{i}} \cdot \frac{{P}_{i}}{{I}_{s , i} + {I}_{o , i} + {N}_{t}} \qquad ( 2 )$$

where W is a bandwidth, 3.84 MHz in the present invention, vᵢ is the activity of the call i, Lᵢ is the path loss of the call i, rᵢ is the rate of the call i, Pᵢ is the transmit power of the call i, I_{s,i} is the strength of interference signals received at the MS that has generated the call i from a cell to which the MS belongs, I_{o,i} is the strength of interference signals received at the MS from adjacent cells, and Nₜ is thermal noise.

With respect to the transmit power Pᵢ of the call i, Eq. (2) is expressed as

$${P}_{i} = \frac{{ρ}_{i} {v}_{i} {L}_{i} {r}_{i}}{W} ( {I}_{s , i} + {I}_{o , i} + {N}_{t} ) \qquad ( 3 )$$

Using Eq. (3), the minimum transmit power Pₘᵢₙ is determined by

$$\begin{matrix}{P}_{min} = {P}_{overhead} + {\sum }_{j ∈ S} {P}_{j , min} \\ = {P}_{overhead} + {\sum }_{j ∈ S} \frac{{ρ}_{i} {v}_{j} {L}_{j} {r}_{j , min}}{W} ( {I}_{s , j} + {I}_{o , j} + {N}_{t} ) \\ = {P}_{overhead} + {\sum }_{j ∈ S} \frac{{ρ}_{i} {v}_{j} {L}_{j} {r}_{j , min}}{W} ( {I}_{s , j} + {I}_{o , j} + {N}_{t} ) - \\ {\sum }_{j ∈ S} \frac{{ρ}_{i} {v}_{j} {L}_{j} ( {r}_{j} - {r}_{j , min} )}{W} ( {I}_{s , j} + {I}_{o , j} + {N}_{t} ) \\ = {P}_{used} - {\sum }_{j ∈ S} \frac{{ρ}_{i} {v}_{j} {L}_{j} ( {r}_{j} - {r}_{j , min} )}{W} ( {I}_{s , j} + {I}_{o , j} + {N}_{t} )\end{matrix} \qquad ( 4 )$$

Eq. (4) is derived from

$${P}_{used} = {P}_{overhead} + {\sum }_{j ∈ S} \frac{{P}_{j} {v}_{j} {L}_{j} {r}_{j}}{W} ( {I}_{s , j} + {I}_{o , j} + {N}_{t} ) \qquad ( 5 )$$

where P_{overhead} is the transmit power for an overhead channel such as a pilot channel and S is a set of calls in service within a corresponding cell. Thus, the strength of an interference signal I_{s,j} within the same cell is expressed as

$${I}_{s , j} = \frac{1 - τ}{{L}_{i}} ( {P}_{used} - {P}_{i} ) = \frac{1 - τ}{{L}_{i}} {δ}_{j} {P}_{used} \qquad ( 6 )$$

where τ represents the orthogonality of a channelization code and

$${δ}_{j} = 1 - \frac{{P}_{j}}{{P}_{used}} .$$

On the assumption that the path loss L is negligibly small, the interference signal Iₒ and thermal noise Nₜ from cells adjacent to the cell in which the MS is located can be neglected. Therefore, if the minimum transmit power Pₘᵢₙ is represented with the above-described parameters, Eq. (1) is expressed as

$${P}_{min} + {P}_{min , i} < {P}_{used} - k \frac{( R - {R}_{min} )}{W} {P}_{used} + {P}_{i , min} < {P}_{opt} \qquad ( 7 )$$

where k=(1-τ)pvδ. The BTS can measure the transmitted carrier power P_{used} every predetermined period or when necessary. The rates R and Rₘᵢₙ are changed each time a call is admitted. In this sense, Eq. (7) is simpler than Eq. (1).

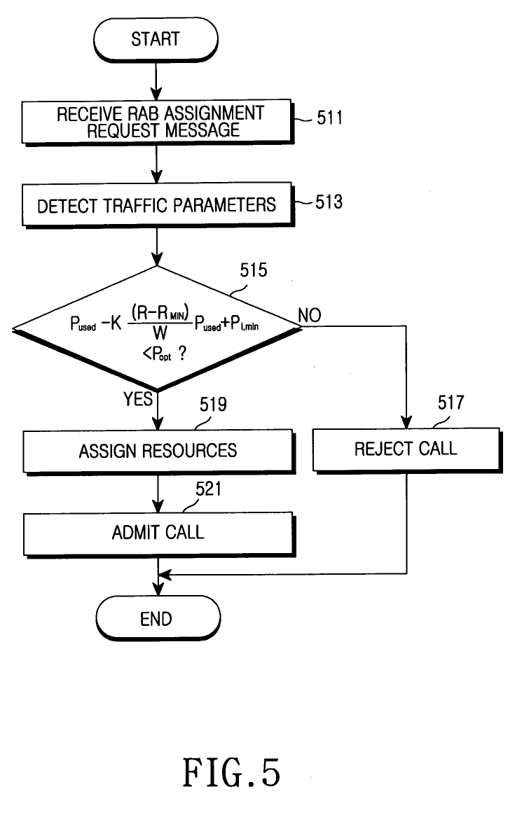

Now, a description will be made of a procedure for determining whether to admit a call i using Eq. (7) with reference to FIG. 5.

FIG. 5 is a flowchart illustrating another operations for performing a call admission according to an embodiment of the present invention. Steps 511 and 513, and steps 517 to 521 are performed in the same manner as steps 411 and 413, and steps 417 to 421 illustrated in FIG. 4. Thus, their detailed description is not provided here. While the BTS compares the sum of the minimum transmit power Pₘᵢₙ and the transmit power required to service the call i at its minimum rate with the optimum transmit power Pₒₚₜ in step 415 of FIG. 4, it determines whether to admit the call i using Eq. (7) in the procedure of FIG. 5.

That is, the BTS compares

$${P}_{used} - k \frac{( R - {R}_{min} )}{W} {P}_{used} + {P}_{i , min}$$

with

$${P}_{opt} ( i . e . , {P}_{used} - k \frac{( R - {R}_{min} )}{W} {P}_{used} + {P}_{i , min} < {P}_{opt} )$$

in step 515. If

$${P}_{used} - k \frac{( R - {R}_{min} )}{W} {P}_{used} + {P}_{i , min} \geq {P}_{opt} ,$$

the BTS notifies the BSC that the call cannot be admitted in step 517 and terminates the call admission procedure.

On the contrary, if

$${P}_{used} - k \frac{( R - {R}_{min} )}{W} {P}_{used} + {P}_{i , min} < {P}_{opt} ,$$

the BTS determines that the call can be admitted and assigns transmit power to the call in step 519. The BTS then processes the call in step 521 and terminates the call admission procedure.

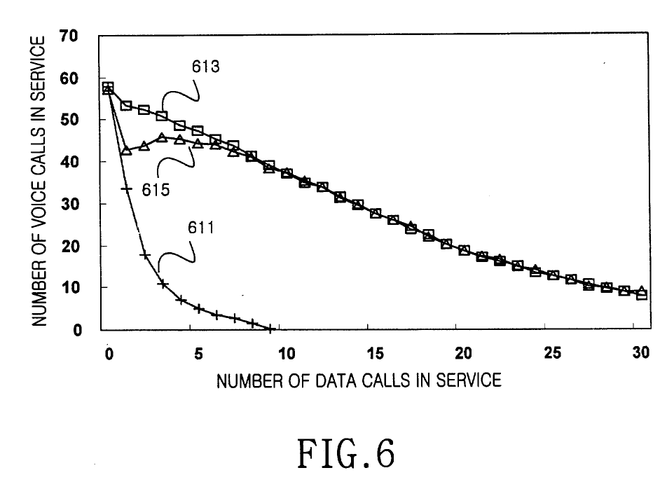

As described above, since the BTS determines whether to admit a call according to the minimum transmit power Pₘᵢₙ required to service all ongoing calls at their minimum rates, even if a best-effort type call is admitted and all available resources are assigned to the call, later calls can also be admitted. As a result, service fairness is improved in terms of call success rates and the call success rates of calls requesting admission are also increased. Call success rates in the call admission method according to the present invention and those in the conventional call admission method will be described with reference to FIG. 6.

FIG. 6 is a graph illustrating a comparison of call success rates in the conventional call admission method and call success rates in the call admission method according to an embodiment of the present invention.

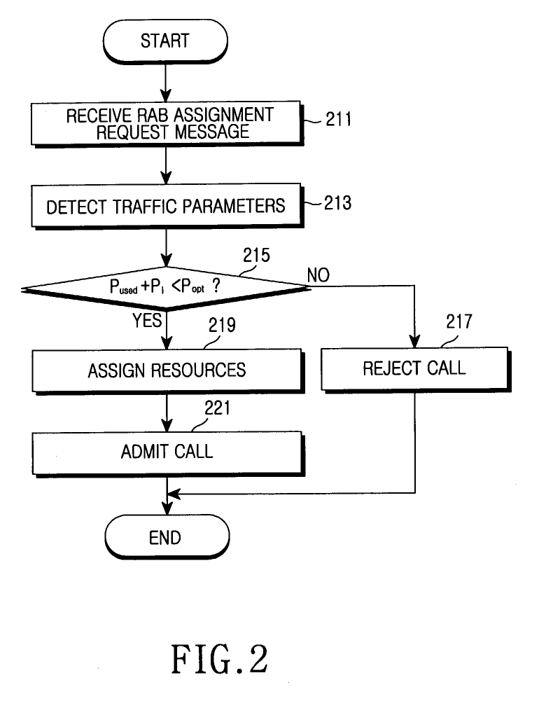

Referring to FIG. 6, a curve 611 indicates the average number of data calls in service versus the average number of voice calls in service according to the conventional call admission method illustrated in FIG. 2. A curve 613 indicates the average number of data calls in service versus the average number of voice calls in service according to the call admission method illustrated in FIG. 4. A curve 615 indicates the average number of data calls in service versus the average number of voice calls in service according to the call admission method illustrated in FIG. 5. Here, the constant k is 0.75 in step 515 of FIG. 5 in the call admission method that results in the curve 615.

As noted from FIG. 6, as data calls increase in number, the blocking rate of voice calls increases in the conventional call admission method as illustrated in FIG. 2. When the call admission method illustrated in FIG. 4 is adopted, most data and voice calls can be serviced. In the call admission method illustrated in FIG. 5, the numbers of data calls and voice calls that can be serviced are approximate to those in the call admission method illustrated in FIG. 4. Since call admission is decided based on the minimum transmit power Pₘᵢₙ in an embodiment of the present invention, cell capacity is not reduced much even when best effort-based data calls occupy most of the resources.

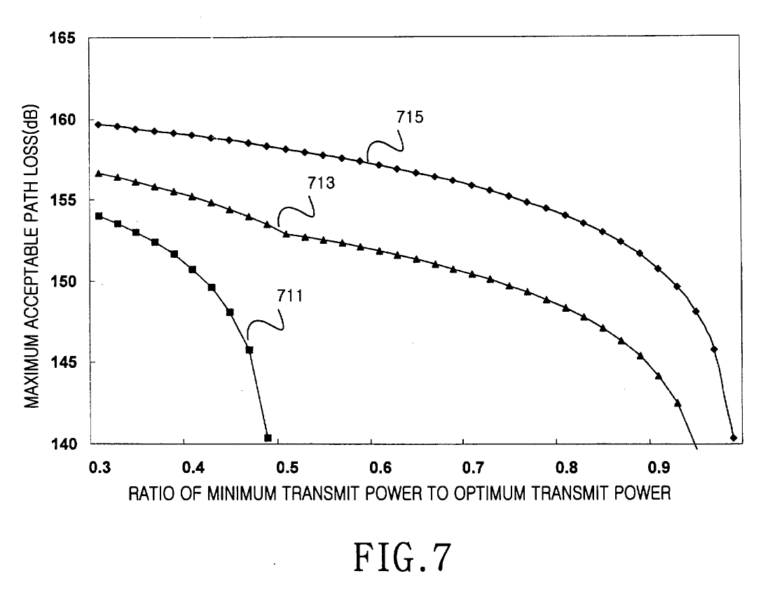

The maximum acceptable path loss according to the optimum transmit power Pₒₚₜ and the minimum transmit power Pₘᵢₙ will be described below with reference to FIG. 7.

FIG. 7 is a graph illustrating a comparison of a maximum acceptable path loss versus the ratio of the minimum transmit power Pₘᵢₙ to the optimum transmit power Pₒₚₜ using a conventional call admission method and a call admission method according to an embodiment of the present invention.

Referring to FIG. 7, a curve 711 indicates the maximum acceptable path loss versus the ratio of the minimum transmit power Pₘᵢₙ to the optimum transmit power Pₒₚₜ in the conventional call admission method that was illustrated in FIG. 2. A curve 713 indicates maximum acceptable path loss versus the ratio of the minimum transmit power Pₘᵢₙ to the optimum transmit power Pₒₚₜ in the call admission method illustrated in FIG. 4. A curve 715 indicates the maximum acceptable path loss versus the ratio of the minimum transmit power Pₘᵢₙ to the optimum transmit power Pₒₚₜ in the call admission method illustrated in FIG. 5. Here the constant k is 0.75 in step 515 of FIG. 5 in the call admission method that results in the curve 715.

As noted from FIG. 7, even if the minimum transmit power Pₘᵢₙ is far less than the optimum transmit power Pₒₚₜ, too much transmit power is already consumed for best effort-based data calls, thereby rapidly decreasing the maximum admittable path loss, when a call is admitted using the conventional call admission method. On the other hand, the maximum acceptable path loss is maintained constant even if the minimum transmit power Pₘᵢₙ reaches the optimum transmit power Pₒₚₜ, when a call is admitted in the call admission methods of the present invention.

As described above, the present invention offers the benefit of efficient distribution of system power resources and fair power distribution to calls requesting admission by determining whether to admit a call in consideration of the minimum transmit power of calls in service. In addition, the QoS classes of the calls in service are further considered when determining whether to admit a new call. As a result, system service quality is improved.

While the invention has been shown and described with reference to certain embodiments thereof, it will be understood by those skilled in the art that various changes in form and details may be made therein without departing from the spirit and scope of the invention as defined by the appended claims.

What is claimed is:

1. A call admission apparatus for guaranteeing a quality of service (QoS) in a mobile communication system, comprising:
a call state information collector for collecting call state information about calls in service; and
a call admission controller for detecting from the call state information a minimum transmit power required to maintain the QoS for each of the calls in service, upon sensing a call admission request for a new call, and admitting the new call only if the sum of the total minimum transmit power of the calls in service and the minimum transmit power required to maintain the QoS of the new call is less than a predetermined optimum transmit power.

2. The call admission apparatus of claim 1, wherein the minimum transmit power is a transmit power required to service a call at a minimum rate corresponding to the QoS of the call.

3. The call admission apparatus of claim 1, wherein the optimum transmit power, is a maximum transmit power available to the mobile communication system.

4. The call admission apparatus of claim 1, wherein the call admission controller rejects the new call if the sum of the total minimum transmit power of the calls in service and the minimum transmit power of the new call is equal to or greater than the optimum transmit power.

5. A call admission method for guaranteeing a quality of service (QoS) in a mobile communication system, comprising the steps of:
detecting a minimum transmit power required to maintain QoS for each of the calls in service upon sensing a call admission request for a new call; and
admitting the new call only if the sum of the total minimum transmit power of the calls in service and the minimum transmit power required to maintain the QoS of the new call is less than a predetermined optimum transmit power.

6. The call admission method of claim 5, wherein the minimum transmit power is a transmit power required to service a call at a minimum rate corresponding to the QoS of the call.

7. The call admission method of claim 5, wherein the optimum transmit power is a maximum transmit power available to the mobile communication system.

8. The call admission method of claim 5, further comprising the step of:
rejecting the new call if the sum of the total minimum transmit power of the calls in service and the minimum transmit power of the new call is equal to or greater than the optimum transmit power.

9. A call admission method for guaranteeing a quality of service (QoS) in a mobile communication system, comprising the steps of:
detecting a first transmit power assigned to calls in service upon sensing a call admission request for a new call;
calculating a third value by subtracting a second value from a first value, said second value comprising a sum of minimum rates required to maintain the QoS of the calls in service, said first value comprising a sum of the current rates of the calls in service;
calculating a fifth value by multiplying the third value by a fourth value, said fourth value comprising a bandwidth of the mobile communication system;
calculating a sixth value by subtracting the fifth value from the first transmit power; and
admitting the new call only if a seventh value comprising the sum of the sixth value and a minimum transmit power required to maintain the QoS of the new call is less than a predetermined optimum transmit power.

10. The call admission method of claim 9, wherein the minimum transmit power is transmit power required to service a call at a minimum rate corresponding to the QoS of the call.

11. The call admission method of claim 9, wherein the optimum transmit power is a maximum transmit power available to the mobile communication system.

12. The call admission method of claim 9, further comprising the step of:
rejecting the new call if the seventh value is equal to or greater than the optimum transmit power.
